(19) United States
(12) Patent Application Publication
(10) Pub. No.: US 2026/0017670 A1
(43) Pub. Date: Jan. 15, 2026

(54) METHOD FOR OPTIMIZING A CARBON EMISSION REDUCTION IN A PROCESS INDUSTRY AND A SYSTEM THEREOF

(71) Applicant: Honeywell International Inc., Charlotte, NC (US)

(72) Inventors: LingaThurai Palanisamy, Bangalore (IN); Venkata Venkamsetty, Bangalore (IN); Harish Iniyarajan, Chennai (IN)

(21) Appl. No.: 18/772,305

(22) Filed: Jul. 15, 2024

(51) Int. Cl. G06Q 30/018; G06Q 10/04

(52) U.S. Cl. CPC G06Q 30/018; G06Q 10/04

(57) ABSTRACT

The present invention relates to a method and a system for optimizing a carbon emission reduction in a process industry. The method comprises identifying one or more processes being run in the process industry and identifying one or more assets associated with the each of the running processes, the information of one or more assets being stored in an asset repository. Further, the method comprises determining an energy demand profile of each of the processes, said profile identifies an energy requirement in running of the process and determining the carbon emission of the process based on the energy demand profile of each of the processes. The method further includes identifying an availability of one or more green energy resources for acquiring the green energy by the process industry and receiving additional data comprising at least one of: an asset health index of the assets in each of the processes, an acquirable amount of the green energy from each of the available green energy resources, wherein each green energy resource is associated with a carbon weightage and a cost, and a weather forecast for a predetermined time period for a location of the process industry. Further, the method comprises executing an optimization model to provide at least one recommendation providing a green energy requirement for each of the processes based on the received additional data, the energy demand profile and the carbon emission of the process.

### TECHNICAL FIELD

Present disclosure relates to a system and a method of optimizing green energy usage. More particularly, the present disclosure provides a method and a system for optimizing a carbon emission reduction in a process industry.

### BACKGROUND

Typically, a manufacturing industry uses power supply from grids for meeting their energy requirements and the grids supply may be from coal, natural gas and thermal energy. In order to curb carbon emissions, a mandate for any manufacturing industry is to reduce their carbon emission and to earn carbon credits for reduction of the emission. As the technology advances, the green energy can now be utilized for reducing carbon emission and some of the green energy resources include solar, wind, hydro, biomass and tidal sources.

However, any manufacturing industry before opting for green energy needs to take into consideration (i) carbon emission reduction index of the processes, (ii) assets involved in processes and asset health index, remaining useful life of asset, (iii) carbon credits associated with green energy resources, and (iv) return on investment (RoI) based on rates, Govt. rebates, tax etc.

There are two ways of reducing the emission namely, improving the process optimization so that the emission reduced and secondly generate their energy requirement through the renewable then their net balance carbon emission is neutralized.

There exists a need for an advisory solution with built in process knowledge which could reduce the emission level in process industry and help the industry to achieve the carbon credit goal.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure herein provide a method and a system for optimizing the carbon emission reduction in a process industry. Other implementations will be, or will become, apparent to one with skill in the art upon examination of the following figures and detailed description. It is intended that all such additional implementations be included within this description be within the scope of the disclosure.

In one embodiment, the present invention relates to a method for optimizing a carbon emission reduction in a process industry. The method comprises identifying one or more processes being run in the process industry and identifying one or more assets associated with the each of the running processes, the information of one or more assets being stored in an asset repository. Further, the method comprises determining an energy demand profile of each of the processes, said profile identifies an energy requirement in running of the process and determining the carbon emission of the process based on the energy demand profile of each of the processes. Further, the method includes identifying an availability of one or more green energy resources for acquiring the green energy by the process industry and receiving additional data comprising at least one of: an asset health index of the assets in each of the processes, an acquirable amount of the green energy from each of the available green energy resources, wherein each green energy resource is associated with a carbon weightage and a cost, and a weather forecast for a predetermined time period for a location of the process industry. Further, the method comprises executing an optimization model to provide at least one recommendation providing a green energy requirement for each of the processes based on the received additional data, the energy demand profile and the carbon emission of the process.

In another aspect, the present invention provides a system for optimizing a carbon emission reduction in a process industry, said system comprising one or more processors, a memory and one or more programs stored in a memory, the one or more programs when executed by the processor, cause the processor to identify one or more processes being run in the process industry and identify one or more assets associated with the each of the running process, the information of one or more assets being stored in an asset repository. Further, the processor is configured to determine an energy demand profile of each of the processes, said profile identifies an energy requirement in running of the process and determine the carbon emission of the process based on the energy demand profile of each of the processes. Further, an availability of the one or more green energy resources is identified for acquiring the green energy by the process industry and receive additional data comprising at least one of: an asset health index of the assets in each of the processes, an acquirable amount of the green energy from each of the available green energy resources, wherein each green energy resource is associated with a carbon weightage and a cost, and a weather forecast for a predetermined time period for a location of the process industry. Further, the processor is configured to execute an optimization model to provide at least one recommendation providing a green energy requirement for each of the processes based on the received additional data, the energy demand profile and the carbon emission of the process. The processor is further configured to generate one or more simulations to provide the recommendations to acquire the green energy from the one or more green energy resources based on at least one of the additional data, the energy demand profile, and the carbon emission of each of the processes.

In an embodiment, the processor is configured to determine a return on investment (ROI) corresponding to each of the simulations based on the additional data, the energy demand profile, and the carbon emission of each of the processes. Further, the processor is configured to monitor the carbon emission of each of the processes, associated assets and provide a feedback to the optimization model to recalculate the green energy requirement of each of the processes.

In another aspect, the processor is configured to determine a carbon credit associated with the process industry and determine the remaining carbon credit corresponding to the one or more simulations generated by the optimization model. In an embodiment, the asset health index is determined using either principle component analysis or a neural network. Further, a Bayesian regression algorithm is used to determine the remaining useful life of each of the assets. In yet another embodiment, the processor is configured to determine one or more newly available green energy resources in identifying the availability of the green energy resources and further, the processor is also configured to predict the availability of the green energy resources based on real time weather data.

In yet another embodiment, the present invention provides a non-transitory computer-readable storage medium storing program instructions for optimizing a carbon emission reduction in a process industry, the instructions, when executed, perform the steps of identifying one or more processes being run in the process industry and identifying one or more assets associated with each of the running processes, the information of one or more assets being stored in an asset repository. Further, the program, when executed, configured to determine an energy demand profile of each of the processes, said profile identifying an energy requirement in running the process and determine the carbon emission of the process based on the energy demand profile of each of the processes. Further the program, when executed, is configured to identify an availability of one or more green energy resources for acquiring green energy by the process industry and receive additional data, comprising at least one of: an asset health index of the assets in each of the processes, an acquirable amount of the green energy from each of the available green energy resources, wherein each green energy resource is associated with a carbon weightage and a cost, and a weather forecast for a predetermined time period for a location of the process industry. Further, the program when executed, is configured to provide at least one recommendation providing a green energy requirement for each of the processes based on the received additional data, the energy demand profile and the carbon emission of the process.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure.

FIG. 1 illustrates an exemplary system for optimizing carbon emission reduction in a process industry, in accordance with an embodiment of the present disclosure;

FIG. 2 illustrates an exemplary carbon emission reduction module, in accordance with an embodiment of the present disclosure;

FIG. 3 illustrates an exemplary emission monitoring module to optimize the functioning of the carbon emission reduction module, in accordance with an embodiment of the present disclosure;

FIG. 4 illustrates an exemplary forecast module, in accordance with an embodiment of the present disclosure;

FIG. 5 illustrates block diagram of carbon emission optimization and recommendation module, in accordance with an embodiment of the present disclosure;

FIG. 6 illustrates an exemplary system for optimization of the green energy usage based on a selection module and a recommendation module, in accordance with an embodiment of the present disclosure;

FIG. 7 illustrates an exemplary process for training the optimization model for determining green energy usage selection and optimization, in accordance with one embodiment of the present disclosure;

FIG. 8 illustrates a flow-chart for providing optimization of green energy usage based on selection module and recommendation module, in accordance with one embodiment of the present disclosure; and

FIG. 9 illustrates general architecture of the system for implementation, in accordance with an embodiment of the present invention.

The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

### DETAILED DESCRIPTION OF THE INVENTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

An industry generally uses power supply from grids for operation of the process within the industry and there may be numerous assets involved in executing the industrial process. The industry may be using grid supply which can be from coal, natural gas, thermal energy, which results in carbon emissions. Further, each of the assets may be in certain health condition and therefore, may add/contribute to the net carbon emission. Given the current carbon emission across the world and in order to curb the global warming, there is a mandate for manufacturing industries to reduce their carbon emission and to earn carbon credits for reduction of the emission.

The production of electrical energy from renewable sources (such as solar, wind, biomass, hydro, and tidal) is being promoted worldwide as a long-term sustainable alternative to fossil fuel reserves and to limit the net addition of greenhouse gases into the world environment due to climate change Paris Proclamation. The villages/cities and communities (will be referred to as community hereafter) in all nations have the option to generate energy at their locations. The community can generate energy locally and can buy from (or sell to) a centralized energy grid to address its energy demand. In today's dynamic energy pricing (in which energy price depends on quantum and time of use), ‘when’ and ‘how much’ are the important questions to answer concerning local renewable energy production and purchase from (or sale to) centralized energy grid. Both these questions are further complicated by the constraints associated with renewable energy production. It should be noted that the quantum produced from renewable sources fully depends on the availability of these (solar, wind, tidal, hydro, and biomass) forms. Hence dynamic pricing, fluctuating production from renewable energy sources, and availability of storage facilities are making it necessary to develop a decision support system that will help the community to best utilize the available renewable resources to meet its demand with a minimal energy bill.

The need to develop a technical system to handle dynamic pricing, fluctuating production from renewable energy sources, and availability of storage facilities for meeting the community's energy demand with a minimum bill, motivated the development of a decision support system discussed in the present disclosure.

With rapid emergence of green energy resources such as solar energy, wind energy, tidal energy, bio mass energy, geo-thermal energy etc., the manufacturing unit/industry now will have the option of utilizing the available green energy resources for their industrial process thereby reducing carbon emission and earn carbon credit.

In general, the carbon credits are permission slips that allow a particular industry to emit a certain amount of carbon dioxide or other greenhouse gases (GHGs). For example, one credit permits the emission of one ton of carbon dioxide or the equivalent of other greenhouse gases. Industries which pollutes and emit greenhouse gases are issued credits that allow them to continue to pollute up to a certain limit. The industry can sell unused credits to other industries that need them, so that the industries which saves carbon credits are incentivized to reduce greenhouse emissions.

Any manufacturing industry before opting for green energy needs to take into consideration (i) carbon emission reduction index of the processes, (ii) assets involved in processes and asset health index, remaining useful life of asset, (iii) carbon credits associated with green energy resources and (iv) return on investment (RoI) based on rates, Govt. rebates, tax etc.

The manufacturing industry may reduce the emission by optimization of the process so that the emission reduced and generate their energy requirement through the renewable, so that their net balance carbon emission is neutralized. For example, the health index of the assets gives an indication about efficiency of the system. The system which operates on the low efficiency is identified by a high health index. This indicates a need for a proper maintenance plan so that it operates in high efficiency which in turn reduce emission. Also, there is a need to assess a remaining useful life of the assets involved in each of the processes. If the remaining useful life of the assets is low, it can result in increased carbon emission.

In general, there is a need for an advisory solution/optimization model with built-in process knowledge, which could reduce the emission level in the process industry and help the industry to achieve the carbon credit goal through proper assessment of health of asset.

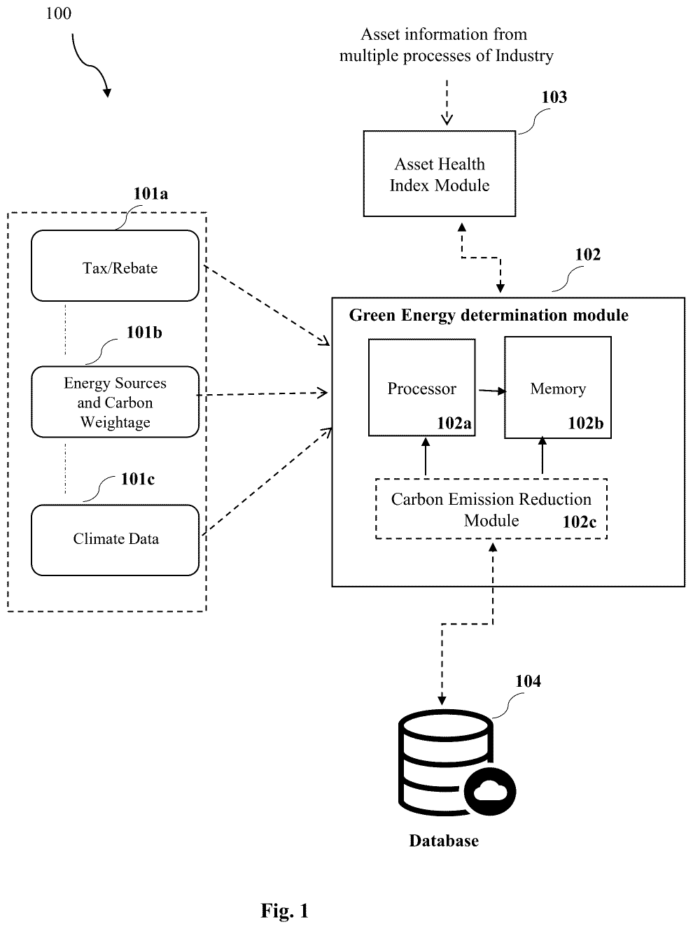

FIG. 1 illustrates an exemplary system 100 for optimizing the carbon emission reduction in a process industry, in accordance with an embodiment of the present disclosure.

The system 100 for optimization of carbon emission reduction comprises a green energy determination module 102, an asset health determination module 103 and a database 104. In an industrial process, there are numerous processes which runs using the grid supply and such processes involves one or more assets. The assets may be an equipment, a sensor or any hardware unit which are involved in running the processes. The asset health determination module 103 is configured to receive the operation parameters of the one or more assets and determine the health index of each of the assets involved in the process. In an embodiment, the asset health determination module 103 is configured to determine the remaining useful life of each asset based on the health index. In an embodiment, the asset health determination module 103 determines the health index of the assets using either a Principal component analysis or a neural network. Further, the asset health determination module 103 is configured to determine the remaining useful life of the assets using Bayesian regression algorithm.

In an embodiment, the asset heath determination module 103 is coupled to the green energy determination module 102. The Green energy determination module 102 comprises a processor 102a, a memory 102b and a Carbon Emission Reduction (CER) module 102c. Further, the green energy determination module 102 is coupled to a database 104. In one embodiment, the database 104 is configured to store various data such as data/parameters relating to processes in determining green energy consumption, return on Investment (ROI) data, process data, knowledge graph of various processes, its corresponding energy consumption data and carbon emissions, assets id and its corresponding health index and remaining useful life of assets.

The CER module 102c is coupled to the processor 102a, the memory 102b and is configured to perform one or more functions, including, but not limited to determining carbon emission reduction index of the processes, determining one or more assets involved in processes and asset health index, determining remaining useful life of asset, determining weather forecast and availability of green energy resources, determining carbon credits associated with green energy resources, determining return on investment (RoI) based on rates, Govt. rebates, tax etc.

The power demand is classified into various types or classes such as agricultural, domestic, commercial and industrial. The priority and purchase cost for each demand class is different at same time. Moreover, the priority and purchase price for same demand class various with respect to time. The power demand from all the classes is fulfilled by production from renewable generation units, usage of stored power and purchase from centralized grid. Sometimes it becomes difficult to meet the demand using all the available resources. In such scenarios, the minimum demand should be met for each demand class. The minimum demand for a demand class at given time slot depends on the priority of the demand class at that time slot. The aim of the Green Energy Determination (GED) module 102 is to meet the demand completely with minimum energy bill. If supply is not sufficient to meet the demand fully, the objective becomes minimization of demand slippage (gap between demand and supply) followed by cost minimization.

As generally known, carbon credits allow them to continue to pollute up to a certain limit that's periodically reduced. The industries, however, can sell any unneeded credits to other companies that need them so private companies are doubly incentivized to reduce greenhouse emissions.

In one embodiment, the GED module 102 is configured to receive information from a plurality of sources which is necessary for the module 102 to make intelligent decision on utilization of green energy resources. In one embodiment, the plurality of sources includes at least (i) Climate data, (ii) Available green energy resources and its respective carbon weightage, and (iii) tax/rebate which is allowable based on green energy usage. In one embodiment, the climate data may include prediction on weather forecast based on season of the year and available green energy resources based on weather forecast. In an example, while solar energy may be available in abundance during summer season, the wind energy may be available in sufficient quantity during spring/rainy seasons. Further, the data on available green energy resources may include data providing quantum of energy available in each of the categories of green energy and such data may also depends upon the location of the industry and its vicinity to the green energy generation location. Further, the data relating to tax/rebate may include the tax rebates or discounts which may be offered based on type of green energy resources.

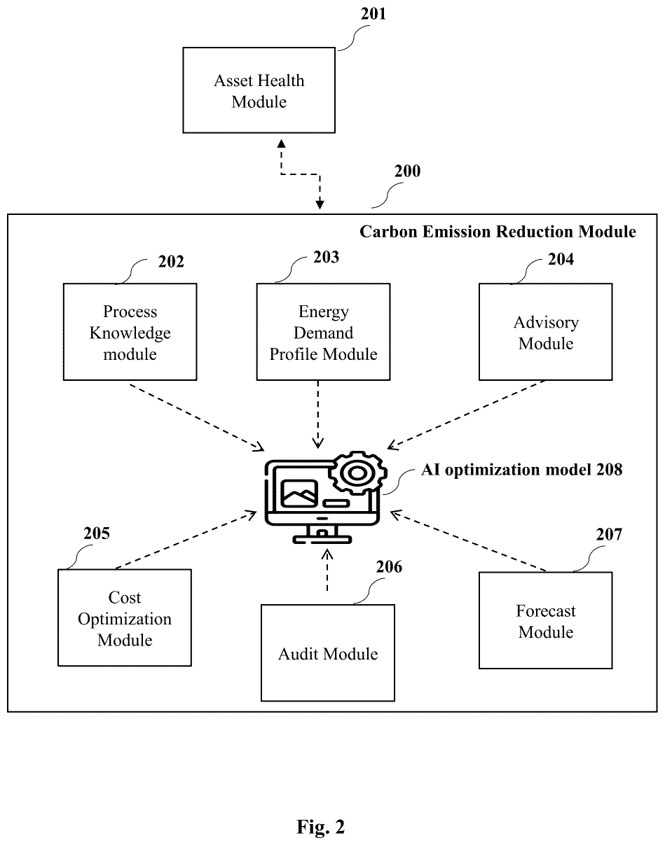

Based on one or more information/data received by the GED module 102, the GED module 102 may present one or more recommendations to an operator of the industry for selection on a user interface UI (not shown). In an exemplary embodiment, the user interface may be a handheld device or a computer. The user interface may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Embodiments of the CER module 102c will now be explained in more detail with reference to FIG. 2.

FIG. 2 illustrates an exemplary carbon emission reduction (CER) module 200, in accordance with an embodiment of the present disclosure. In an embodiment, the CER module 200 is coupled to an asset health module 201 and said CER module 200 comprises process a knowledge module 202, an energy demand profile module 203, an advisory module 204, a cost optimization module 205, an audit module 206 and a forecast module 207. In an embodiment, one or more modules i.e., the knowledge module 202, the energy demand profile module 203, the advisory module 204, the cost optimization module 205, the audit module 206 and the forecast module 207 are coupled to an Artificial Intelligence (AI) model 208 which is a trained model on various parameters and is configured to one or more recommendations in selecting green energy resources which has better carbon credit index and return on investment (RoI).

In an embodiment, the knowledge module 202 may include a variety of information such as manuals, guides, and policies. The knowledge module 202 may include internal knowledge base storing information specific to the industrial facility, such as internal policies, procedures, and best practices. The knowledge module may store information on various processes which are run in the industry, various assets which are involved in each process, the order in which the processes are executed and the resources working in the industrial environment. In an embodiment, the energy demand profile module 203 may determine the energy required for running each of the processes and also, the energy requirement profile of each asset which are involved in executing a particular process. In an example, the asset health index is taken into consideration as deteriorating health of an asset may result in more consumption of energy as compared to an asset which has improved heath index.

The advisory module 204 of the CER module 200 provides one or more data to the optimization model, which may include data advising on which process requires grid supply or green energy supply, operating periods of various process based on production capacity.

In a further embodiment, the cost optimization module 205 provides cost benefit analysis to the optimization model 208. As mentioned above, the dynamic energy pricing may be implementable based on the constraints associated with renewable energy production and fluctuating production from renewable energy sources. The cost optimization module 205 is configured to assess the cost benefit based on selection of a particular green energy resource to meet the industrial process demand and suggest the same to the optimization model 208. Further, the audit module 206 is configured to determine a return on investment (ROI) corresponding to one or more selection of green energy resources and determine carbon credit based on reduction of carbon emission by optimization of energy usage.

In a further embodiment, the forecast module 207 is configured to provide weather prediction data to the AI optimization model. In one embodiment, the weather prediction data may be collected from the publicly available weather forecasts data with respect to a particular location. The weather/climate data may include prediction on weather forecast based on season of the year and available green energy resources based on weather forecast. In an example, while solar energy may be available in abundance during summer season, the wind energy may be available in sufficient quantity during spring/rainy seasons.

The AI optimization model 208 receives the data from one or more modules 202, 203, 204, 205, 206 and 207 and is configured to generate one or more recommendations for selection by the operator of the industrial process and the recommendation may be based on Return on Investment (RoI), cost benefit analysis and carbon credits associated with usage of green energy resources. In an embodiment, the optimization model 208 is configured to generate one or more simulations to provide the recommendations to acquire the green energy from the one or more green energy resources. Further, the optimization model 208 is configured to determine a carbon credit associated with the process industry and determine the remaining carbon credit corresponding to the one or more simulations generated by the optimization model 208.

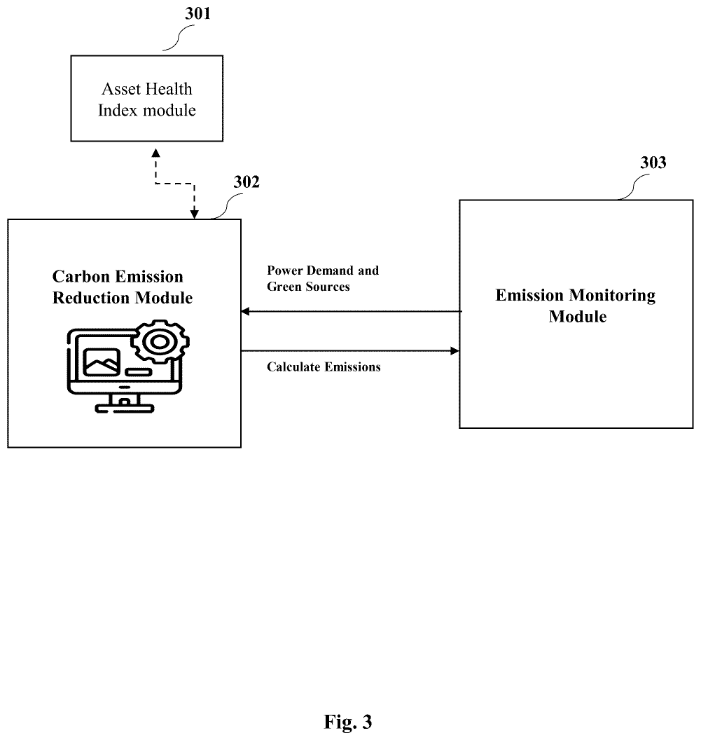

FIG. 3 illustrates an exemplary emission monitoring module 303 to optimize the functioning of the carbon emission reduction module, in accordance with an embodiment of the present disclosure. In an embodiment, the CER module 302 is coupled to the asset health index module 301 and receives the health index data of one or more assets involved in running of processes. Further, the CER module 302 is coupled to the emission monitoring module 303 according to an embodiment. The emission monitoring module 303 is configured to continuously monitor the current emission level of each of the industrial processes and provide the same as a feedback to the CER module 302.

The emission monitoring module 303 provides the emission details of one or more processes, which may enable the CER module 302 to make intelligent decision on procuring the green energy resources. In an example, the processes in a particular time or season, may have less emission and the information on the same is provided to the CER module 302 for taking a decision. Based on data on current emission, if it is determined that the industry will have enough carbon credits, the industry may refrain from purchasing the green energy resources. However, during prolonged time (specifically during busy production), the carbon emission may be higher and may result in speedy expiry of carbon credits, the CER module may use this data to make determination on how much and when to procure the green energy supply to reduce the carbon emissions.

In an embodiment, the CER module 302 may provide the emission monitoring module 303, the data on current energy demand and the green energy supply being used currently in running the processes. The emission monitoring module 303 may determine, using the information of current energy demand and green energy being used, whether the current emission of the industrial process is within the threshold limit. If the emission monitoring module 303 determines that the emission is within the threshold limit according to historical data, the module 303 may intimate the same to the CER module 302. However, if the emission monitoring module 303 determines that the emission has exceeded the threshold limit based on current emission data, the module 303 may provide a feedback to the CER module 302 which may include need to either verify the asset health involved in the process or need to procure more green energy resources. In an embodiment, the feedback to the CER module 302 may include balance carbon credit available for exhaustion.

In an embodiment, the emission monitoring module 303 may be configured to measure the green-house gases from the emission vents of the industrial process.

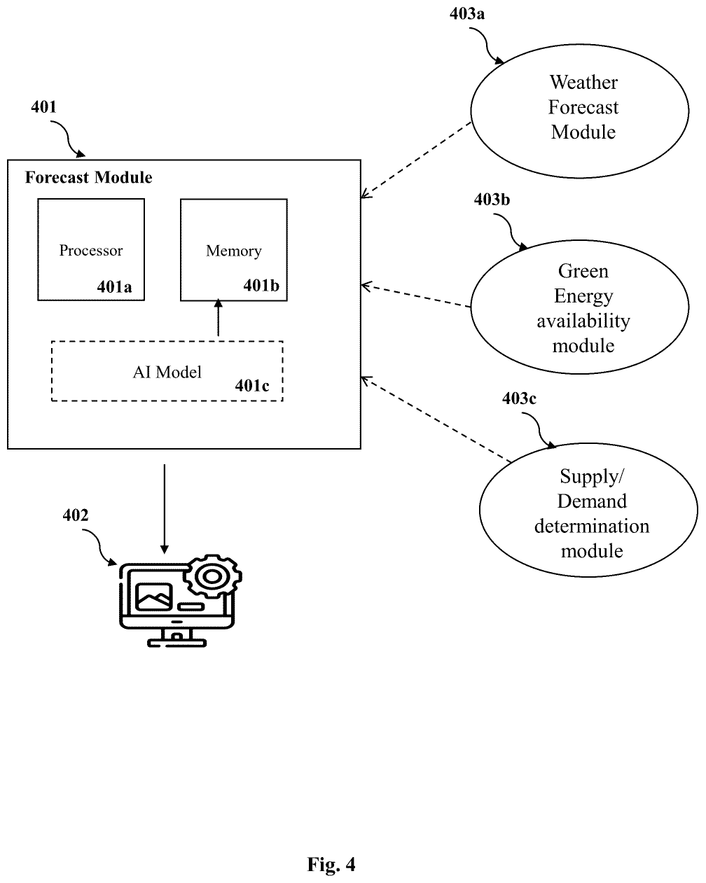

FIG. 4 illustrates an exemplary forecast module 401, in accordance with an embodiment of the present disclosure. The forecast module 401 is configured to collect one or more information which is predictive of upcoming weather conditions, available green energy resources and supply/demand data and provide the collected data to the optimization model 402 for decision making. In an embodiment, the forecast module 401 is coupled to a weather forecast module 403a, a green energy available module 403b, a supply/demand determination module 403c.

It is evident that the supply of the green energy resources is largely dependent on weather fluctuations as the source of the green energy is either water, wind or solar energy. For example, while solar energy may be available in abundance in summer season, the same may not be available in sufficient amount in rainy/winter seasons due to lack of sun's exposure. Similarly, while wind energy may be available in good quantity during spring seasons, the same may not be available during summer season or when the winds are not predominantly present. Therefore, it is important to provide information on weather forecast to the AI optimization model 402, so that the decision on effective utilization of green energy resources can be made.

In an embodiment, the weather forecast module 403a provides weather forecast information to the forecast module 401. The weather forecast module 403a may obtain the weather forecast information from the publicly available resources for example national weather services, Accu-weather. By utilizing the weather forecast information, it may be determined that whether a particular green energy resource (solar/wind/tidal/biomass) will or will not available during a pre-determined time period.

In another embodiment, the green energy available module 403b provides the information regarding the availability of green energy resources. In an embodiment, the availability of green energy may vary based on usage pattern. For example, the green energy sources may be predominantly routed to the agricultural processes during a specific time period, thereby less available to the industrial processes. In another example, one or more facilities which generates green energy resources may mal-function or undergo maintenance shut down which may result in non-availability of the energy during maintenance time period. In another embodiment, there can be purchase limit on green energy based on industry type. In another embodiment, the availability date of green energy may vary at different time of the day. The green energy available module 403b may further identify newly available green energy resources.

In another embodiment, the supply/demand determination module 403c may predict the supply of green energy resources based on dynamic pricing. In a particular season of the year, the production of green energy may be low, thereby lowering the supply and increased demand in the market. This may change the dynamic pricing of the green energy resources and may be very costly due to less supply and more demand.

The forecast module 401 receives the information on weather forecast data, energy availability data or supply/demand data and provides the same to an AI model 401c. The AI model 401c processes the received data and provide a forecast index to the optimization model of the CER module. The CER module may receive the forecast index and may determine the procurement of green energy.

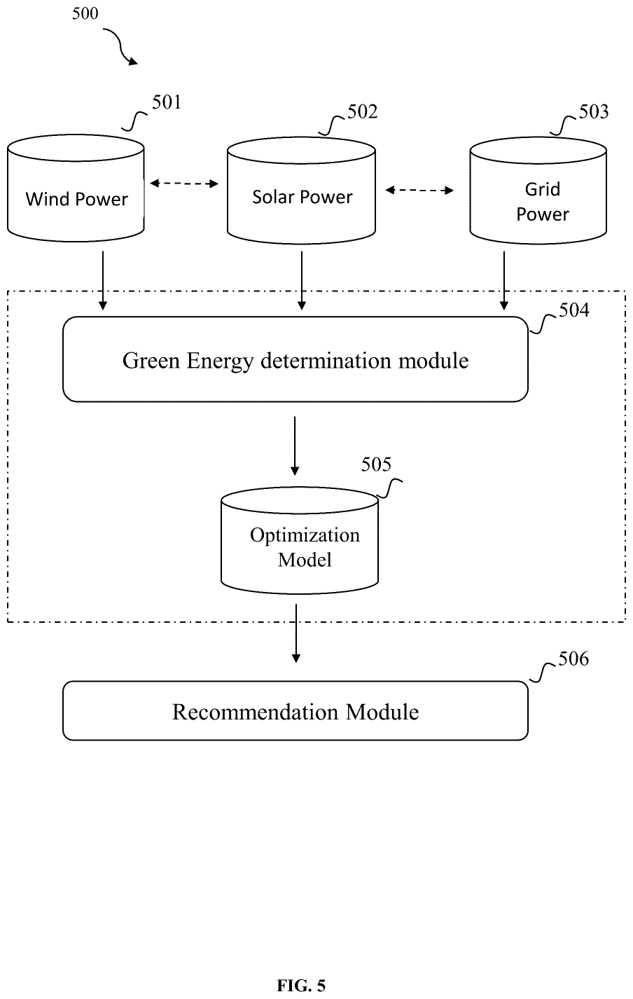

FIG. 5 illustrates block diagram of a carbon emission optimization and recommendation module, in accordance with an embodiment of the present disclosure. In an embodiment, a recommendation module 506 is provided to simulate one or more different scenarios based on availability of green energy resources and provide the same to the operator of the industry process for selection. In an embodiment, the recommendation module 506 is coupled to an optimization model 505 of the green energy determination module 504. The optimization model 505 after receiving one or more information as explained in FIG. 2 and provides one or more recommendations via the user interface to the operator.

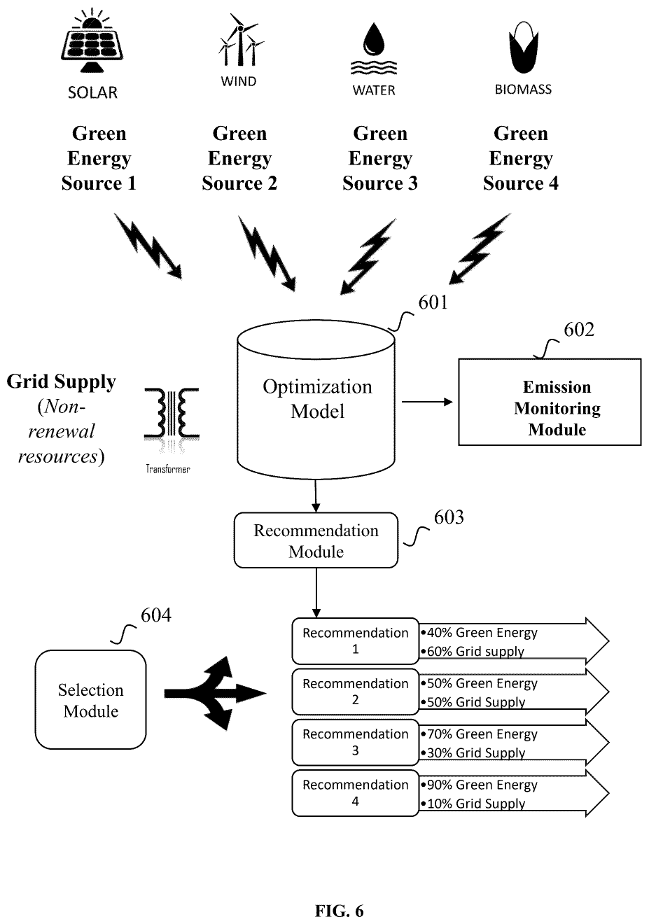

FIG. 6 illustrates an exemplary system for optimization of green energy usage based on selection module and recommendation module, in accordance with an embodiment of the present disclosure.

As illustrated in FIG. 6, the industry process may meet their energy demand from various sources such as Grid supply (which is non-renewable resources) and also, one or more green energy resources such as Solar Energy, Wind Energy, Tidal Energy, Bio Mass energy etc. The optimization model 601 is coupled to the Emission monitoring module 602 and the recommendation module 603. Based on determination by the emission monitoring module 602 that the emission includes green-house gases and one or more green energy supply may be utilized to reduce emission, the same is intimated to the optimization model.

In an embodiment, the optimization model 601 receives input indicating one or more green energy resources along with its quantum, cost, carbon weightage, dynamic pricing information, availability information, weather forecast information. The optimization model 601 is also configured to receive asset health information and remaining useful life. The optimization model 601 is configured to execute the optimization algorithms which may include Decision support Mixed Integer Linear (DSMIL) programming to identify which of the green energy may be purchased for meeting energy demand based on availability and dynamic pricing and to reduce the carbon emission to save carbon credits.

In an embodiment, the recommendation module 603 is provided which is coupled to the optimization model 601. Based on execution of DSMIL programming, the optimization model 601 may identify more than one scenario where green energy sources may be utilized. One scenario may differ from the other in terms of its advantages and the operator of the industry may select any of the presented option for meeting the energy demand. The recommendation model 603 may be coupled to the user interface (not shown) of the user and is configured to present to the user, one or more scenarios with an associated description and advantages.

In a further embodiment, a selection module 604 may be presented on the user interface, which enables the operator to select at least one recommended option, for implementation. In an embodiment, the selection module 604 may enable the operator to utilize different recommended options at a different time slot. The operator may select recommendation option R₁ at time slot T₁, option R₂ at time slot T₂, option R₃ at time slot T₃, option R₄ at time slot T₄, and any combination thereof.

In yet another embodiment, the optimization model 601 may be configured to calculate the savings in carbon credits by way of utilizing one or more recommended scenarios. Further, the optimization model 601 may be configured to continuously receive feedback from the emission monitoring module 602. Based on the carbon credit savings and emission data, the optimization model 601 is configured to be re-trained so that the optimization algorithm may be improved to consider additional consideration.

In one example, there may additional renewable sources available which were not available previously, for example, biomass energy. Upon considering new options for renewal sources, the optimization model may re-execute the DSMIL programming to identify one or more new scenarios for selection by the operator.

In yet another embodiment, the optimization model 601 is configured to re-execute the DSMIL after a predetermined time period to determine one or more new scenarios to be presented to the operator of the industry.

In this way, the optimization model may take into consideration various factors in presenting scenarios to the operator of the industry, thereby effectively managing carbon credits and cost factor.

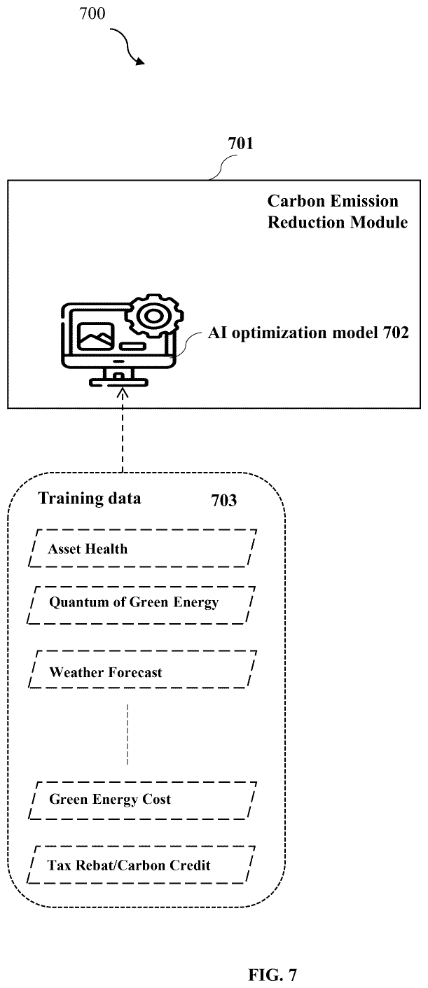

FIG. 7 illustrates an exemplary process for training the optimization model for determining green energy usage selection and optimization, in accordance with one embodiment of the present disclosure.

The optimization model 702 is configured to be trained based on various parameters, based on which the optimization model 702 provides one or more recommendations for selection by the operator on procurement on green energy resources. The CER module 701 is coupled to a training data 703, wherein the training data 703 includes data which is collected by different modules as described in FIG. 2. For optimization model 702 to effectively process various data, training the optimization model 702 is an inherent step in execution of the process. The optimization model 702 is trained on plurality of data and such data on which the model 702 is trained includes:
a. Asset health information and remaining useful life;
b. Quantum of available green energy;
c. Weather forecast information;
d. Cost of green energy available at a predetermined time slot;
e. Available carbon credit information;
f. Tax rebate information on usage of particular green energy;

The carbon emission reduction (CER) module includes the optimization model which takes into consideration the energy requirement data, carbon emission data, asset health index for executing an optimization algorithm. In an embodiment, the optimization algorithms include Decision support Mixed Integer Linear programming.

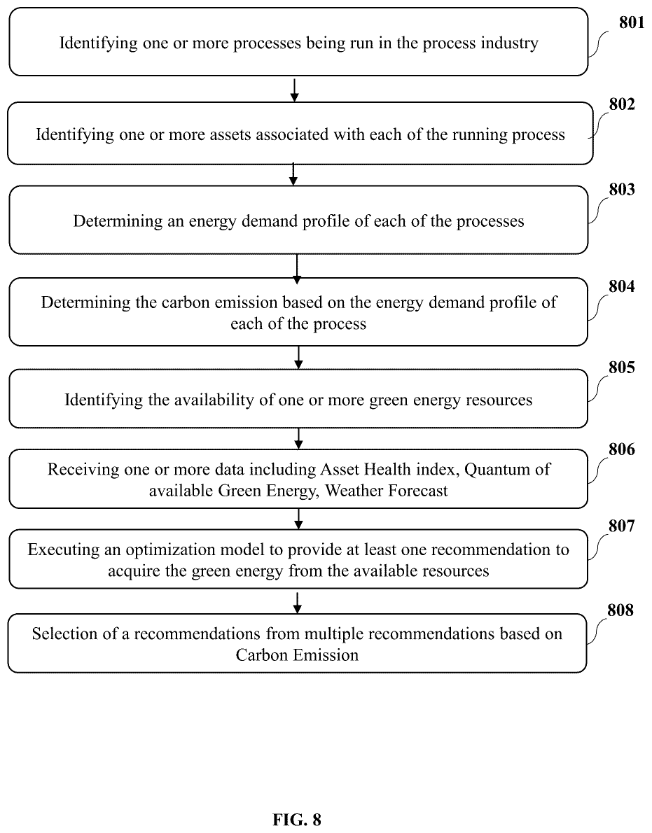

FIG. 8 illustrates a flow-chart for providing optimization of green energy usage based on selection module and recommendation module, in accordance with one embodiment of the present disclosure.

In Step 801, one or more processes are identified which are being run in the process industry. In an industrial process, there are numerous processes which runs using the grid supply and such processes involves one or more assets. In one embodiment, one or more processes may be run in sequential manner or in parallel. Further, in yet another embodiment, various processes may be run in different time slots thereby varying the carbon emission at different time period.

In Step 802, one or more assets are identified associated with each of the running process. The assets may be an equipment, a sensor or any hardware unit which are involved in running the processes. The asset health determination module is configured to receive the operation parameters of one or more assets and determine the current health index of each asset involved in the process. In an embodiment, the asset health determination module is configured to determine the remaining useful life of each asset based on health index. In an embodiment, the asset health determination module determines the health index of the assets using Principal component analysis or using a neural network. Further, the asset health determination module is configured to determine remaining useful life of the assets using Bayesian regression algorithm.

In Step 803, an energy demand profile of each of the processes is identified. The power demand is classified into various types or classes such as agricultural, domestic, commercial and industrial. The priority and purchase cost for each demand class is different at same time. Moreover, the priority and purchase price for same demand class various with respect to time. The power demand from all the classes is fulfilled by production from renewable generation units, usage of stored power and purchase from centralized grid. Sometimes it becomes difficult to meet the demand using all the available resources. In such scenarios, the minimum demand (must fill) should be met for each demand class. The minimum demand for a demand class at given time slot depends on the priority of the demand class at that time slot.

In step 804, the carbon emission is determined based on the energy demand profile of each of the process. Each of the process in an industrial set-up may have a different energy demand based on its complexity/heavy machinery and execution time. While one process may require more energy, there may be processes which may require very little energy, for example indicators and sensors. Therefore, it is important to determine the energy demand profile of each of the process to make efficient decisions as regards to selection between grid supply and renewal sources of energy. Further, while some processes may have carbon emission, some of the process such as measurements/indicators/general display equipment may have very little to no carbon emission which is taken into consideration while determining energy demand profile of the processes.

In Step 805, the availability of one or more green energy resources is identified. The production of electrical energy from renewable sources (such as solar, wind, biomass, hydro, and tidal) is being promoted worldwide as a long-term sustainable alternative to fossil fuel reserves and to limit the net addition of greenhouse gases into the world environment due to climate change with emergence of green energy resources such as solar energy, wind energy, tidal energy, bio mass energy, geo-thermal energy etc. The industry will have the option of utilizing the available green energy resources for their process thereby reducing carbon emission and earn carbon credit. In one embodiment, availability of one or more green energy sources is determined by the forecast module based on weather prediction data. In one embodiment, the weather prediction data may be collected from the publicly available weather forecasts data with respect to a particular location. The weather/climate data may include prediction on weather forecast based on season of the year and available green energy resources based on weather forecast. In an example, while solar energy may be available in abundance during summer season, the wind energy may be available in sufficient quantity during spring/rainy seasons. In yet another embodiment, the industry may have access to one type of green sources, but may not have access to other kinds of renewal sources due to not having connection between the source and destination.

In Step 806, one or more data is received including Asset Health index, Quantum of available Green Energy, Weather Forecast. In an embodiment, the CER module is coupled to an asset health module and said CER module comprises process a knowledge module, an energy demand profile module, an advisory module, a cost optimization module, an audit module and a forecast module. The knowledge module may include a variety of information such as manuals, guides, policies, and information specific to the industrial facility, such as internal policies, procedures, and best practices. The knowledge module may store information on various processes which are run in the industry, various assets which are involved in each process, the order in which the processes are executed and the resources working in the industrial environment. The energy demand profile module may determine the energy required for running each of the processes and also, the energy requirement profile of each asset which are involved in executing a particular process. In an example, the asset health index is taken into consideration as deteriorating health of an asset may result in more consumption of energy as compared to an asset which has improved heath index. The advisory module of the CER module provides one or more data to the optimization model, which may include data advising on which process requires grid supply or green energy supply, operating periods of various process based on production capacity. The cost optimization module provides cost benefit analysis to the optimization model. The dynamic energy pricing may be implementable based on the constraints associated with renewable energy production and fluctuating production from renewable energy sources. The cost optimization module is configured to assess the cost benefit based on selection of a particular green energy resource to meet the industrial process demand and suggest the same to the optimization model. Further, the audit module is configured to determine a return on investment (ROI) corresponding to one or more selection of green energy resources and determine carbon credit based on reduction of carbon emission by optimization of energy usage. Further, the forecast module is configured to provide weather prediction data to the AI optimization model. In one embodiment, the weather prediction data may be collected from the publicly available weather forecasts data with respect to a particular location. The weather/climate data may include prediction on weather forecast based on season of the year and available green energy resources based on weather forecast.

In Step 807, the optimization model is executed to provide at least one recommendation to acquire the green energy from the available resources. The optimization model receives the data from different modules and is configured to generate one or more recommendations for selection by the operator of the industrial process and the recommendation may be based on Return on Investment (RoI), cost benefit analysis and carbon credits associated with usage of green energy resources. The recommendation module is coupled to the optimization model and based on execution of DSMIL programming, the optimization model may identify more than one scenario where green energy sources may be utilized. One scenario may differ from the other in terms of its advantages and the operator of the industry may select any of the presented option for meeting the energy demand. The recommendation model may be coupled to the user interface (not shown) of the user and is configured to present to the user, one or more scenarios with an associated description and advantages.

Further, the optimization model may be configured to continuously receive feedback from the emission monitoring module. Based on the carbon credit savings and emission data, the optimization model is configured to be re-trained so that the optimization algorithm may be improved to consider additional consideration. In one example, there may additional renewable sources available which were not available previously, for example, biomass energy. Upon considering new options for renewal sources, the optimization model may re-execute the DSMIL programming to identify one or more new scenarios for selection by the operator. In yet another embodiment, the optimization model is configured to re-execute the DSMIL after a predetermined time period to determine one or more new scenarios to be presented to the operator of the industry. In yet another embodiment, the optimization model may be configured to calculate the savings in carbon credits by way of utilizing one or more recommended scenarios.

In Step 808, selection of one or more recommendations from multiple recommendations based on carbon emission is discussed. The selection module may be presented on the user interface (not shown), which enables the operator to select at least one recommended option, for implementation.

In an embodiment, the selection module may enable the operator to utilize different recommended options at a different time slot. The operator may select recommendation option R₁ at time slot T₁, option R₂ at time slot T₂, option R₃ at time slot T₃, option R₄ at time slot T₄, and any combination thereof.

In yet another embodiment, based on selected option, a feedback may be presented to the optimization model to verify if the determined scenarios match the actual output in terms of carbon emission. The feedback signal may include determination of carbon emission by emission monitoring module and cost data associated with utilizing one or more green energy resources.

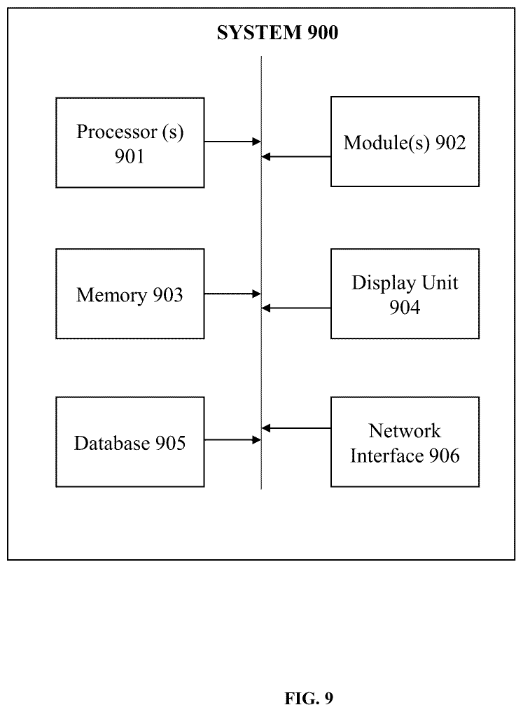

FIG. 9 illustrates a general block diagram of the system, according to an embodiment of the present disclosure.

In an example, the processor(s) 901 may be a single processing unit or a number of units, all of which could include multiple computing units. The processor(s) 901 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor(s) 901 is configured to fetch and execute computer-readable instructions and data stored in a memory 903.

The memory 903 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the module(s), engine(s), and/or unit(s) 902 may include a program, a subroutine, a portion of a program, a software component or a hardware component capable of performing a stated task or function. As used herein, the module(s), engine(s), and/or unit(s) may be implemented on a hardware component such as a server independently of other modules, or a module can exist with other modules on the same server, or within the same program. The module(s), engine(s), and/or unit(s) 902 may be implemented on a hardware component such as processor one or more microprocessors, microcomputers, microcontrollers, digital signal processors, central processing units, state machines, logic circuitries, and/or any devices that manipulate signals based on operational instructions. The module(s), engine(s), and/or unit(s) 902 when executed by the processor(s) 901 may be configured to perform any of the described functionalities. According to an embodiment, the module 902 includes one or more modules discussed above. In an alternate embodiment, the functions of the aforesaid modules may be performed by the processor(s) 901.

As a further example, the database 905 may be implemented with integrated hardware and software. The hardware may include a hardware disk controller with programmable search capabilities or a software system running on general-purpose hardware. Examples of databases are but are not limited to, in-memory databases, cloud databases, distributed databases, embedded databases, and the like. The database amongst other things, serves as a repository for storing data processed, received, and generated by one or more of the processors(s) 901, and the modules/engines/units.

The modules/engines/units 902 may be implemented with an AI module that may include a plurality of neural network layers. Examples of neural networks include, but are not limited to, a convolutional neural network (CNN), a deep neural network (DNN), a recurrent neural network (RNN), a Restricted Boltzmann Machine (RBM). The learning technique is a method for training a predetermined target device using a plurality of learning data to cause, allow, or control the target device to decide or prediction. Examples of the learning techniques include, but are not limited to, a supervised learning, unsupervised learning, a semi-supervised learning, or reinforcement learning. At least one of a plurality of CNN, DNN, RNN, RMB models and the like may be implemented to thereby achieve execution of the present subject matter's mechanism through an AI model. A function associated with the AI model may be performed through the non-volatile memory, the volatile memory, and the processor. The processor may include one or a plurality of processors. At this time, one or a plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or the artificial intelligence (AI) model stored in the non-volatile memory and the volatile memory. The predefined operating rule or artificial intelligence model is provided through training or learning.

As an example, the display unit 904 includes a computer monitor, a touch screen, an output device capable of displaying the graphics, and the like. The display unit 904 is configured to display visual output in desktops, laptops, and workstations.

As a further example, the network interface 906 is configured to provide and establish communication with any electronic device via a public network, private network, or any wireless communication technology.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms operator, person, employee, worker, labor, personnel, workforce, supervisor, and manager have been used interchangeably throughout the draft and corresponds to an individual working in an industry or directly or indirectly managing operations in the industrial environment.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

What is claimed is:

1. A method for optimizing a carbon emission reduction in a process industry, comprising:
identifying one or more processes being run in the process industry;
identifying one or more assets associated with each of the running processes, the information of one or more assets being stored in an asset repository;
determining an energy demand profile of each of the processes, said profile identifying an energy requirement in running the process;
determining the carbon emission of the process based on the energy demand profile of each of the processes;
identifying an availability of one or more green energy resources for acquiring the green energy by the process industry;
receiving additional data, comprising at least one of:
an asset health index of the one or more assets in each of the processes;
an acquirable amount of the green energy from each of the available green energy resources, wherein each green energy resource is associated with a carbon weightage and a cost;
a weather forecast for a predetermined time period for a location of the process industry; and
executing an optimization model to provide at least one recommendation providing a green energy requirement for each of the processes based on the received additional data, the energy demand profile and the carbon emission of the process.

2. The method of claim 1, further comprising:
generating one or more simulations, by the optimization model, to provide the recommendations to acquire the green energy from the one or more green energy resources based on at least one of: the additional data, the energy demand profile, and the carbon emission of each of the processes

3. The method of claim 2, further comprising:
determining a return on investment (ROI) corresponding to each of the simulations based on the additional data, the energy demand profile, and the carbon emission of each of the processes.

4. The method of claim 1, further comprising:
monitoring the carbon emission of each of the processes and associated assets; and
providing a feedback to the optimization model to recalculate the green energy requirement of each of the processes.

5. The method of claim 2, further comprising:
determining a carbon credit associated with the process industry; and
determining the remaining carbon credit corresponding to the one or more simulations generated by the optimization model.

6. The method of claim 1, wherein the asset health index is determined using either principle component analysis or a neural network.

7. The method of claim 1, wherein identifying the one or more green energy resources for acquiring the green energy by the process industry comprises:
determining one or more newly available green energy resources.

8. The method of claim 1, further comprising:
predicting the availability of the green energy resources based on real time weather data.

9. The method of claim 1, further comprising:
determining the remaining useful life of the asset by using a Bayesian regression algorithm.

10. The method of claim 1, wherein the each of the processes and the assets acquires the energy for its execution, the energy may be one of the green energy, a power grid supply or a combination of both.

11. A system for optimizing a carbon emission reduction in a process industry, comprising:
one or more processors;
a memory; and
one or more programs stored in a memory, the one or more programs when executed by the process, cause the processor to:
identify one or more processes being run in the process industry;
identify one or more assets associated with each of the running process, the information of one or more assets being stored in an asset repository;
determine an energy demand profile of each of the processes, said profile identifying an energy requirement in running the process;
determine the carbon emission of the process based on the energy demand profile of each of the processes;
identify an availability of the one or more green energy resources for acquiring the green energy by the process industry;
receive additional data, comprising at least one of:
an asset health index of the one or more assets in each of the processes;
an acquirable amount of the green energy from each of the available green energy resources, wherein each green energy resource is associated with a carbon weightage and a cost;
a weather forecast for a predetermined time period for a location of the process industry; and
execute an optimization model to provide at least one recommendation providing a green energy requirement for each of the processes based on the received additional data, the energy demand profile and the carbon emission of the process.

12. The system of claim 11, wherein the processor is configured to:
generate one or more simulations to provide recommendations to acquire the green energy from the one or more green energy resources based on at least one of the additional data, the energy demand profile, and the carbon emission of each of the processes.

13. The system of claim 12, wherein the processor is configured to:
determine a return on investment (ROI) corresponding to each of the simulations based on the additional data, the energy demand profile, and the carbon emission of each of the processes.

14. The system of claim 11, wherein the processor is configured to:
monitor the carbon emission of each of the processes and associated assets; and
provide a feedback to the optimization model to recalculate the green energy requirement of each of the processes.

15. The system of claim 12, wherein the processor is configured to:
determine a carbon credit associated with the process industry; and
determine the remaining carbon credit corresponding to the one or more simulations generated by the optimization model.

16. The system of claim 11, wherein the asset health index is determined using either principle component analysis or a neural network.

17. The system of claim 11, wherein the processor is configured to:
determine one or more newly available green energy resources in identifying the availability of the green energy resources.

18. The system of claim 11, wherein the processor is configured to:
predict the availability of the green energy resources based on real time weather data.

19. The system of claim 11, wherein the processor is configured to:
execute a bayesian regression algorithm to determine the remaining useful life of each of the assets.

20. A non-transitory computer-readable storage medium storing program instructions for optimizing a carbon emission reduction in a process industry, the instructions, when executed, perform the steps of:
identifying one or more processes being run in the process industry;
identifying one or more assets associated with each of the running processes, the information of one or more assets being stored in an asset repository;
determining an energy demand profile of each of the processes, said profile identifying an energy requirement in running the process;
determining the carbon emission of the process based on the energy demand profile of each of the processes;
identifying an availability of one or more green energy resources for acquiring the green energy by the process industry;
receiving additional data, comprising at least one of:
an asset health index of the assets in each of the processes;
an acquirable amount of the green energy from each of the available green energy resources, wherein each green energy resource is associated with a carbon weightage and a cost;
a weather forecast for a predetermined time period for a location of the process industry; and
executing an optimization model to provide at least one recommendation providing a green energy requirement for each of the processes based on the received additional data, the energy demand profile and the carbon emission of the process.
